(19) United States
(12) Patent Application Publication
(10) Pub. No.: US 2013/0115794 A1
(43) Pub. Date: May 9, 2013

(54) SMALL FORM FACTOR PLUGABLE CONNECTOR HAVING A LOW PROFILE RELEASING MECHANISM

(71) Applicant: Hon Hai Precision Industry Co., Ltd., New Taipei (TW)

(72) Inventors: HAN-CHUNG CHANG, New Taipei (TW); YUN-CHENG HOU, New Taipei (TW); JOHN CHOW, Saratoga, CA (US)

(73) Assignee: HON HAI PRECISION INDUSTRY CO., LTD., New Taipei (TW)

(21) Appl. No.: 13/668,574

(22) Filed: Nov. 5, 2012

(30) Foreign Application Priority Data
Nov. 4, 2011 (CN) 201110344745.6

(51) Int. Cl. H01R 13/62

(52) U.S. Cl. 439/160

(57) ABSTRACT

A plug connector comprises a housing defining a pair of inserting grooves, and a releasing mechanism assembled to the housing and having a pull portion and a latch. The pull portion comprises a rotator and an extending arm connected with the rotator at a connecting point. The latch comprises a hook and a pair of rotating shafts connected with the rotator. The rotating shafts are received in the inserting grooves. Upon a rearward pulling movement of the pull portion, the connecting point moves rearwardly to rotate the rotator together with the rotating shafts to move the hook from a latched position toward a released position.

### FIELD OF THE INVENTION

The present invention relates to a plug connector having a low profile releasing mechanism.

### DESCRIPTION OF PRIOR ART

U.S. Pat. No. 6,746,264 issued to Branch et al. on Jun. 8, 2004, discloses a pull-to-release latch for latching a module into a mating port. The pull-to-release latch comprises a latch member pivotally mounted to the module for releasably engaging a host electronic system housing and a pull tab latch control member for pivoting the latch member against a spring force. Specifically, the latch member comprises a pair of transverse shafts assembled to the module in a pivotable manner, a latching end, and a camming surface. The control or actuator member comprises a portion engageable with the module and with the camming surface. When pulling the actuator member, the latch member undergoes a pivotal movement about its shafts from an unactuated position to an actuated, released position.

U.S. Pat. No. 6,439,918 issued on Aug. 27, 2002, discloses a plug connector having a releasing mechanism. The releasing mechanism has a pivotable bail for operating a pivot block against restoring force from a leaf spring.

A plug connector having a releasing mechanism of a different construction that can save space is desired.

### SUMMARY OF THE INVENTION

Accordingly, an object of the present invention is to provide a small profile plug connector.

In order to achieve the above-mentioned objects, a plug connector comprises a housing defining a pair of inserting grooves, and a releasing mechanism assembled to the housing and having a pull portion and a latch. The pull portion comprises a rotator and an extending arm connected with the rotator at a connecting point. The latch comprises a hook and a pair of rotating shafts connected with the rotator. The rotating shafts are received in the inserting grooves. Upon a rearward pulling movement of the pull portion, the connecting point moves rearwardly to rotate the rotator together with the rotating shafts to move the hook from a latched position toward a released position.

According to the present invention, the rotator is connected with the rotating shafts and, therefore, directly drives by way of a translational movement the rotating shafts to rotate from a latched position toward a released position. Therefore, the releasing mechanism may occupy a small space.

### BRIEF DESCRIPTION OF THE DRAWINGS

FIG. 1 is an assembled, perspective view of a plug connector in accordance with the present invention;

FIG. 2 is a partially assembled, perspective view of the plug connector shown in FIG. 1;

FIG. 3 is another partially assembled, perspective view of the plug connector shown in FIG. 1;

FIG. 4 is an exploded, perspective view of the plug connector of FIG. 1;

FIG. 5 is an exploded, perspective view of a housing, a releasing mechanism, and an elastic gasket of the plug connector of FIG. 1;

FIG. 6 is a cross-sectional view of the plug connector taken along 6-6 in FIG. 1 when the releasing mechanism is locked; and

FIG. 7 is a cross-sectional view of the plug connector taken along 6-6 in FIG. 1 when the releasing mechanism is released.

### DETAILED DESCRIPTION OF PREFERRED EMBODIMENTS

Reference will now be made to the drawing figures to describe the present invention in detail.

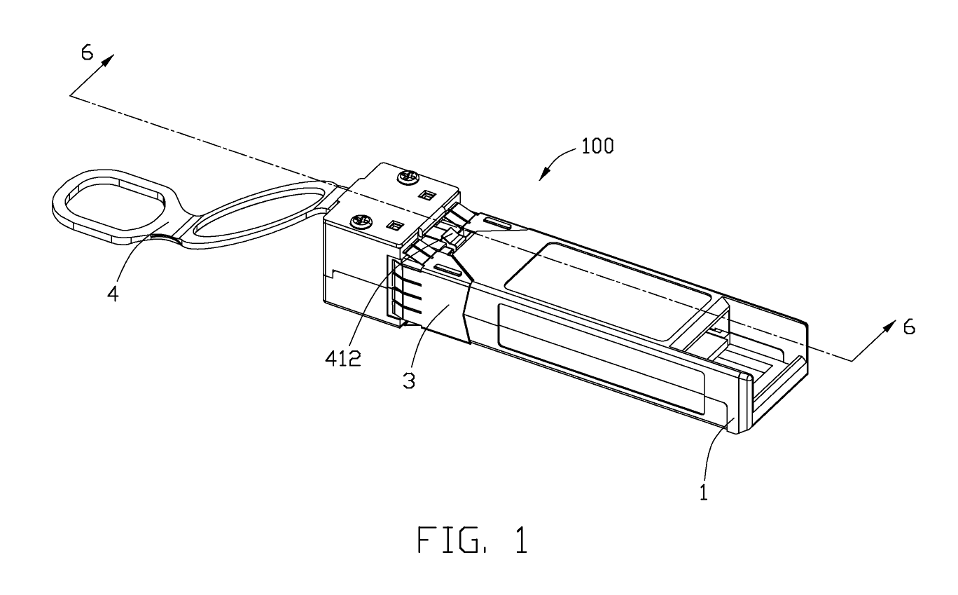

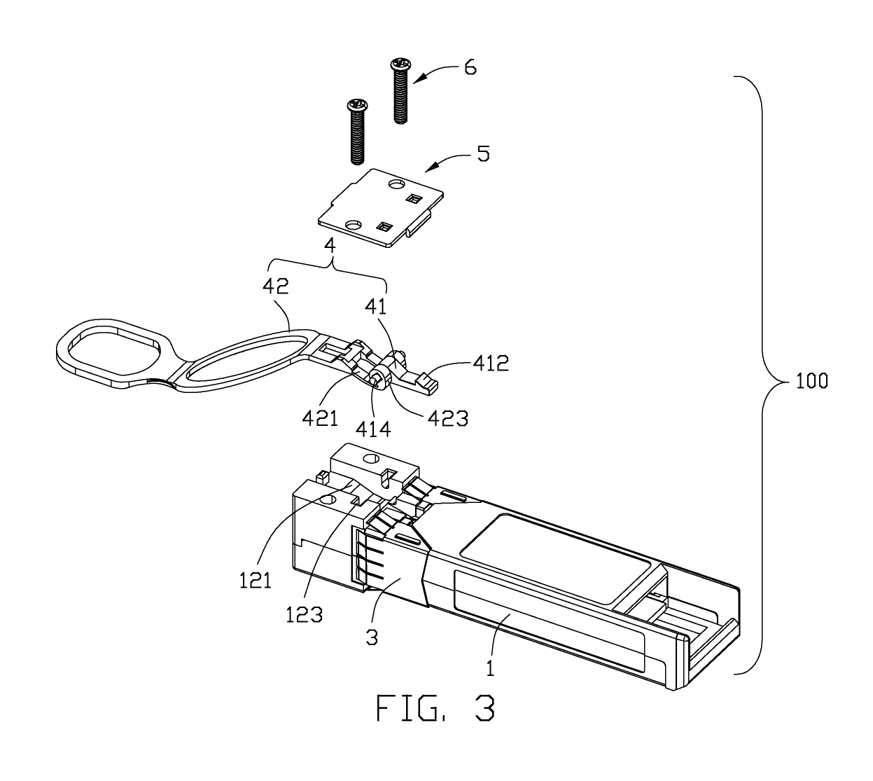

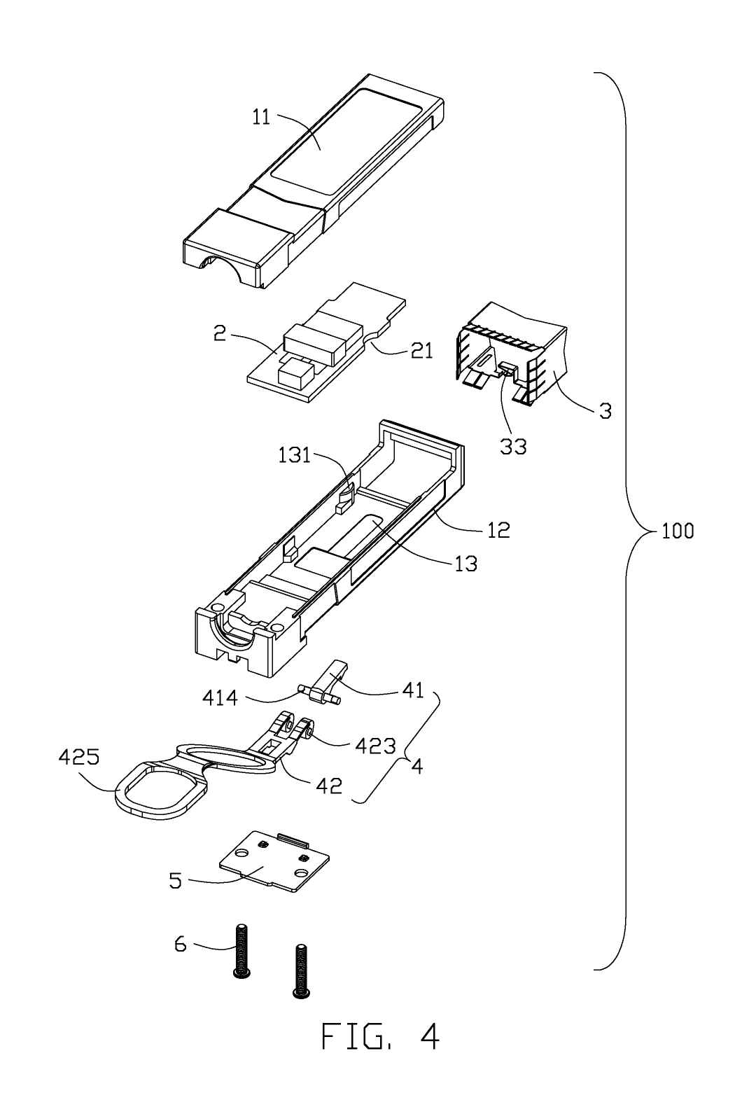

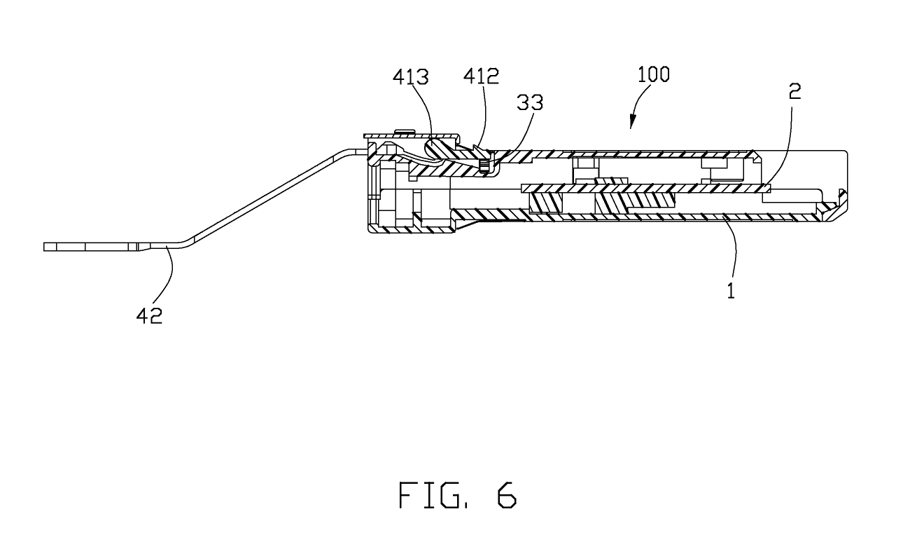

Referring to FIGS. 1 to 7, a plug connector 100 in accordance with the present invention for mating to a complementary connector (not shown), comprises a housing 1, a circuit board 2 receiving in the housing 1, a cable (not shown) connected to the circuit board 2, an elastic gasket 3 enclosing the housing 1, a releasing mechanism 4 mounted to the housing 1, a cover 5 and a pair of screws 6.

The housing 1 comprises a first body portion 11 and a second body portion 11. A receiving space 13 is formed by means of both the first and second body portions 11, 12 mounting together along an upper-to-down direction thereof. A pair of positioning portions 131 are defined in the second body portion 11 and raised toward the receiving space 13. In other embodiments, the housing 1 may be an integrated element by means of die-cast or a pair of first and second body portions 11, 12 forming other structures and mounting together along other directions. The pair of positioning portions 131 can be defined on the first body portion 11.

The second body portion 12 of the housing 1 defines a receiving groove 121 located on the outside surface thereof for receiving the releasing mechanism 4. The receiving groove 121 comprises an accommodating groove 121 located on the front end thereof and recessed downwardly, and a pair of inserting grooves 123 located two sides of the accommodating groove 124. A limiting portion 122 is raised upwardly from the rear end of the receiving groove 121.

The circuit board 2 defines a plurality of conductive pads (not shown) located the front end thereof and a pair of positioning holes 21 located on two sides thereof. The gasket 3 is made of sheet metal and configured to rectangular-shaped frame portion. An “S” shaped spring component 33 is formed on the gasket 3. The spring component 33 is formed on the elastic gasket 3 by integrated stamping.

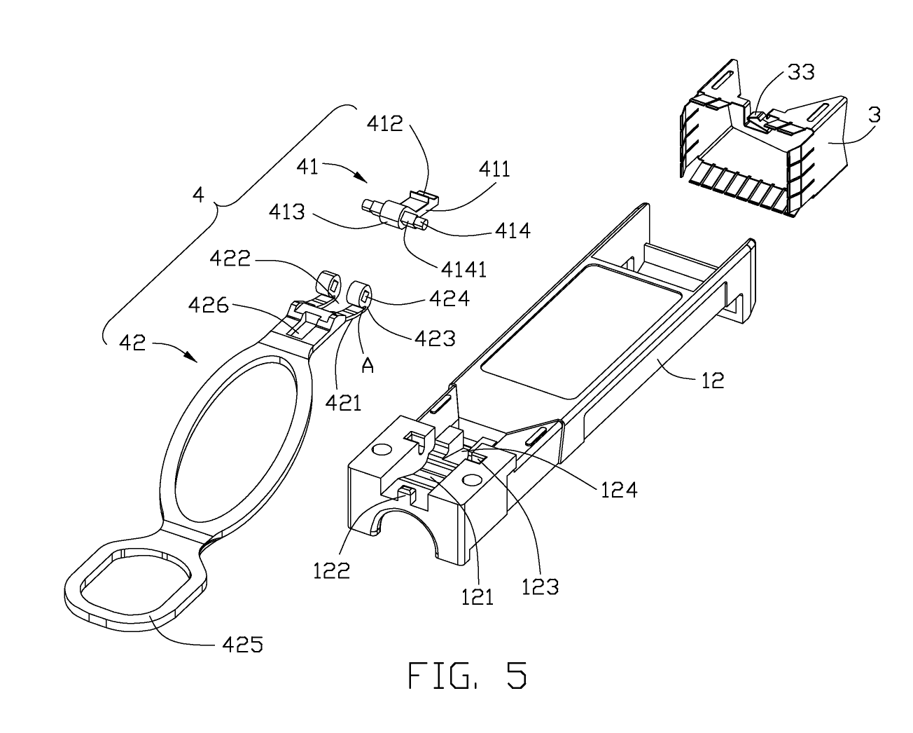

Combination of FIG. 5, the releasing mechanism 4 comprises a latch 41 coordination with the complementary connector and a pull portion 42. The latch 41 comprises a main portion 411 extending longitudinally, a hook 412 defined on the front end of the main portion 411 and a pair of rotating shafts 414 extending transversely. Each of rotating shafts 414 defines a rectangular driving portion 4141. A connecting portion 413 is disposed between two driving portions 4141 and connected the driving portions 4141 with the main portion 411. The pull portion 42 comprises a pair of extending arms 421 extending forwardly, a pair of rotators 423 located on the front end of the extending arms 421, a limiting groove 426 near to the extending arms 421 and a puller 425. A cutout 422 is formed between two rotators 423. A connecting point “A” located between the rotator 423 and the extending arm 421, and located on the bottom of the rotator 423. Each of rotator 423 defines a rectangular hole 424 coordination with rectangular driving portion 4141.

In assembly, a housing 1 is formed by the first and second body portion 11, 12 mounting together along the upper-to-rear direction, and the circuit board 2 is received in the receiving space 13 of the housing 1. The elastic gasket 3 encloses partially the housing 1, and the spring component 33 of the elastic gasket 3 is accommodated in the accommodating groove 124. The rotating shafts 414 of the latch 41 is run through the rotator 423 of the pull portion 42, respectively. The rectangular driving portion 4141 is retained in the rectangular hole 424. The connecting portion 413 is located in the cutout 422 between two rotators 423. Both the rotator 423 and the rotating shafts 414 are maintained fixed relative to each other, and no relative displacement is occurred. The cover 5 covers the receiving groove 121 by the screws 6 fastening the cover 5 onto the housing 1.

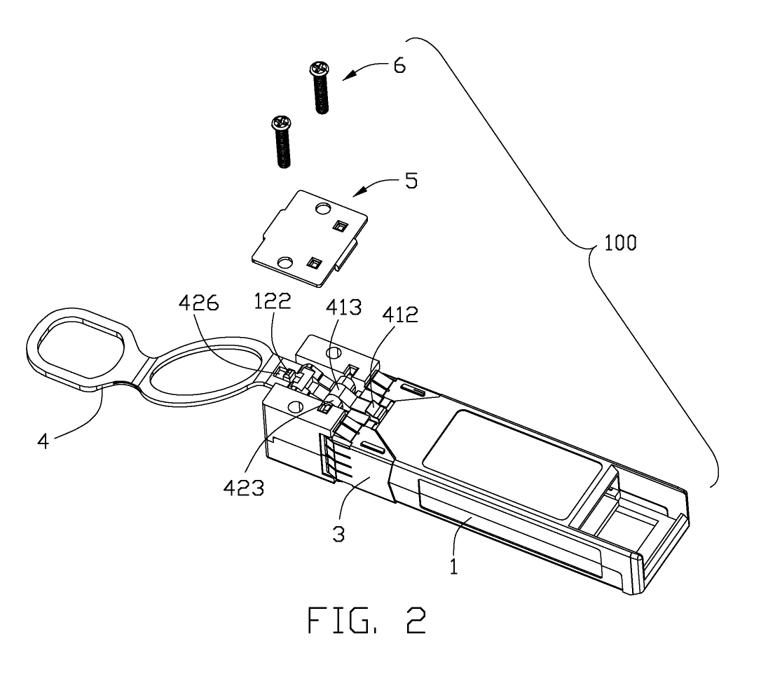

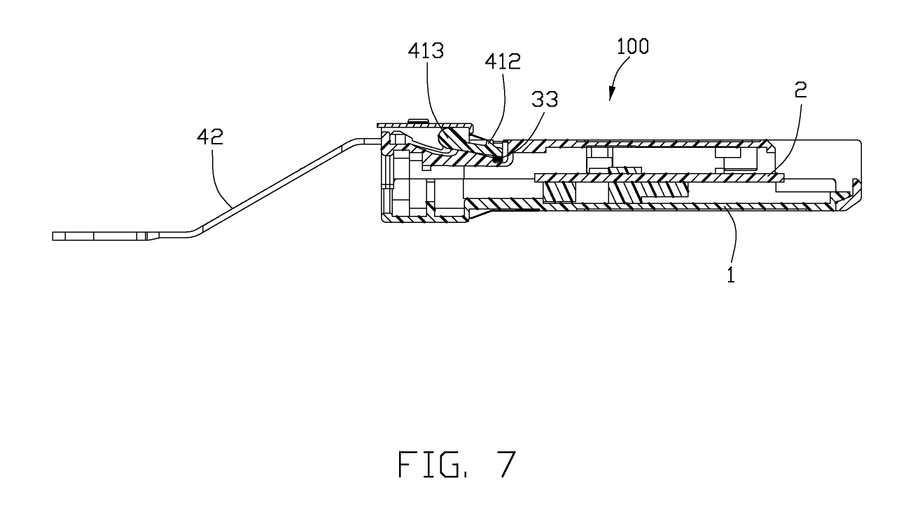

Combination of FIGS. 5 and 7, the connecting points “A” located between the rotator 423 and the extending arms 321 are moved upwardly and rearwardly from the bottom of the rotator 423. Consequently, the rotators 423 and the rotating shafts 414 are rotated together to dive the hook 412 release from a locking position toward a releasing position. Combination of FIG. 2, the limiting portion 122 of the housing 1 is slid in the limiting groove 426 along the front-to-rear direction from preventing the pull portion 42 escaping from the housing 1. Arrived at releasing position and moved downwardly, the hook 412 is supported by spring component 33 located in the accommodating groove 12. After the plug connector 100 is got off the complementary connector, the hook 413 is reset under the elastic force of the spring component 33.

In this embodiment, the pull portion 42 and the latch 41 are two elements. Between the rotator 423 and the rotating shaft 414 can have a slightly relative displacement, but it is needed to fulfill that the rotating shaft 414 can rotate along a direction as same as the rotator's 423 rotating direction. However, in other embodiment, the rotator 423 and the rotating shaft 414 can form a piece by molding to make the pull portion 42 and the latch 41 become an element.

In other embodiments, except of the last rear end of the rotator, the connecting point “A” also is defined on other areas of the rotator 423. The design is needed to fulfill that the connecting portion “A” can move rearwardly to drive the rotator 423 rotate when the pull portion 42 is pulled rearwardly.

This design that the rotator 423 drives directly the rotating shaft 414 rotate in the releasing mechanism 4 only makes the releasing mechanism 4 occupy a small space, and is suitable for the miniaturization of product.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A plug connector comprising:
a housing defining a pair of inserting grooves; and
a releasing mechanism assembled to the housing and having a pull portion and a latch; wherein
the pull portion comprises a rotator and an extending arm connected with the rotator at a connecting point;
the latch comprises a hook and a pair of rotating shafts connected with the rotator, the rotating shafts being received in the inserting grooves; and
upon a rearward pulling movement of the pull portion, the connecting point moves rearwardly to rotate the rotator together with the rotating shafts to move the hook from a latched position toward a released position.

2. The plug connector as recited in claim 1, wherein the rotating shaft has a driving portion retained in the rotator.

3. The plug connector as recited in claim 2, wherein the driving portion has a rectangular cross section, and the rotator has a hole of rectangular cross section.

4. The plug connector as recited in claim 3, wherein the connecting point between the rotator and the extending arm is formed at a bottom of the rotator.

5. The plug connector as recited in claim 4, wherein there are a pair of rotators, and a cutout is formed between the rotators.

6. The plug connector as recited in claim 5, wherein the latch defines a main portion connecting to the hook, and a connecting portion connected between the rotating shafts and the main portion, the connecting portion disposed between the rotators and received into the cutout.

7. The plug connector as recited in claim 1, wherein the housing defines a receiving groove for receiving partially the releasing mechanism.

8. The plug connector as recited in claim 7, further comprising a gasket having a spring component, and wherein the receiving groove has an accommodating groove for resetting the latch.

9. The plug connector as recited in claim 7, wherein the pull tape has a limiting groove and the receiving groove has a limiting portion slidably confined in the limiting groove along a pull force direction.

10. A plug connector comprising:
a housing;
a release mechanism assembled to the housing and defining a pull portion ad a latch,
said latch defining a main portion extending in a front-to-back direction with a hook at a front end, a connecting portion linked to a rear end of the main portion and further defining a pivot shaft;
the pull portion linked to the latch around the connecting portion, wherein
rearward movement of the pull portion results in pivotal movement of the latch so as to change the position of the hook in a vertical direction for unlocking.

11. The plug connector as claimed in claim 10, wherein the hook is moved downward for unlocking.

12. The plug connector as claimed in claim 10, wherein the housing defines a pair of inserting grooves to allow the corresponding pivot shaft to be assembled thereinto in a vertical direction perpendicular to said pivot shaft.

13. The plug connector as claimed in claim 12, further including a cover to retain the latch and the pull portion in position for preventing the pivot shaft from withdrawal from the inserting grooves.

14. The plug connector as claimed in claim 10, wherein said pull portion includes a rotator assembled to the connecting portion without relative rotation therebetween.

15. The plug connector as claimed in claim 14, wherein rearward movement of the pull portion results in rotation of the rotator to have the connecting portion rotated correspondingly.
